(19) United States
(12) Patent Application Publication
(10) Pub. No.: US 2015/0119048 A1
(43) Pub. Date: Apr. 30, 2015

(54) METHOD AND APPARATUS FOR PERCEIVING ACCESS BETWEEN TERMINAL AND SMALL CELL

(71) Applicant: ELECTRONICS AND TELECOMMUNICATIONS RESEARCH INSTITUTE, Daejeon (KR)

(72) Inventors: Mi Jeong YANG, Daejeon (KR); Soon Yong LIM, Daejeon (KR); Kwang Ryul JUNG, Daejeon (KR); Jae Wook SHIN, Daejeon (KR)

(73) Assignee: ELECTRONICS AND TELECOMMUNICATIONS RESEARCH INSTITUTE, Daejeon (KR)

(21) Appl. No.: 14/520,913

(22) Filed: Oct. 22, 2014

(30) Foreign Application Priority Data
Oct. 30, 2013 (KR) 10-2013-0130490
Nov. 1, 2013 (KR) 10-2013-0131906
Oct. 17, 2014 (KR) 10-2014-0140917

(51) Int. Cl. H04W 48/08; H04W 36/22; H04W 16/32

(52) U.S. Cl. CPC H04W 48/08; H04W 16/32; H04W 36/22
USPC 455/444

(57) ABSTRACT

A method and apparatus for perceiving access between a terminal and a small base station is provided. A macro base station transmits a small cell addition/change request message to a small base station that a terminal enters and transmits a message for access to the terminal when receiving a response message from the small base station. Then the macro base station obtains results of access between the terminal and the small base station and determines whether the access between the terminal and the small base station is completed based on the result of access.

### CROSS-REFERENCE TO RELATED APPLICATION

This application claims priority to and the benefit of Korean Patent Application No. 10-2013-0130490, No. 10-2013-0131906, and No. 10-2014-0140917 filed in the Korean Intellectual Property Office on Oct. 30, 2013, Nov. 1, 2013, and Oct. 17, 2014, the entire contents of which are incorporated herein by reference.

### BACKGROUND OF THE INVENTION

(a) Field of the Invention

The present invention relates to a method and apparatus for a base station to perceive access between a small cell and a terminal.

(b) Description of the Related Art

A base station is classified into a macro base station, a pico base station, and a femto base station according to its size of coverage. The macro base station is a base station for covering a wider area compared to the pico base station and the femto base station. In the 3rd generation partnership project (3GPP), the pico base station and the femto base station are referred to as small cells. The small cell represents a cell of lower transmission power and narrower coverage compared to an existing macro cell of higher transmission power and wider coverage. The small cell may include equipment of a base station, for example, equipment of output power lower than 10 W per antenna, a pico cell, femto cell, and others.

Research on various ways for efficiently using a network in which a macro base station and a small base station coexist has been conducted. Small cell performance enhancement techniques have been researched to efficiently process data traffic that is dramatically increasing in a mobile communication system.

In the small cell performance enhancement techniques, a macro cell of wide coverage and small cells being overlapped thereto are to be concentrated so that data traffic is distributed. Here, the performance enhancement is to be provided through inter-node resource aggregation between the macro cell and the small cell and maintaining the dual connectivity between them by a terminal.

The dual connectivity is a scheme for a terminal to simultaneously use radio resources provided from a macro base station and a small base station so that transmission efficiency increases. Some traffic for a terminal flowing to a small cell while maintaining dual connectivity implies that handover between cells is not performed. Therefore, a method for off-loading data to a small cell is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus having advantages of efficiently distributing traffic for a terminal to a small base station by a macro base station in a network environment in which the small base station and the macro base station coexist.

An exemplary embodiment of the present invention provides a method for perceiving access in a network environment in which a macro base station and a small base station coexist. The method includes: transmitting, by the macro base station, a small cell addition/change request message to a small base station that a terminal enters; transmitting, by the macro base station, a message for access to the terminal when receiving a response message from the small base station; obtaining, by the macro base station, results of access between the terminal and the small base station; and determining, by the macro base station, whether the access between the terminal and the small base station is completed based on the result of access.

The obtaining of results of access may include receiving a small cell access status message including results of random access to the small base station from the terminal, and the determining may include perceiving that the access between the terminal and the small base station is completed when the results of the random access included in the small cell access status message represent access success.

The transmitting of a message for access may include transmitting a radio resource control (RRC) connection reconfiguration message to the terminal, and the obtaining of results of access may include receiving an RRC connection reconfiguration complete message including results of random access to the small base station from the terminal.

The determining may include determining whether the access between the terminal and the small base station is completed based on the result of random access included in the RRC connection reconfiguration complete message received after the random access of the terminal to the small base station.

The method may further include: after the transmitting of a message for access, configuring, by the terminal, resources based on contents of the message for access and performing random access to the small base station; and transmitting, by the terminal, a message including results of the random access to the macro base station when receiving a response message including timing information from the small base station according to the random access.

The obtaining of results of access may include receiving a small cell status message including results of random access from the small base station, and the determining may include perceiving that the access between the terminal and the small base station is completed when the results of the random access included in the small cell status message represent access success.

The method may further include: after the transmitting of a message for access, configuring, by the terminal, resources based on contents of the message for access and performing random access to the small base station; receiving, by the terminal, a response message including timing information and uplink grant information from the small base station according to the random access; and transmitting, by the terminal, a random access message to the small base station based on the uplink grant information.

The small cell status message from the small base station may be received by the macro base station when the random access message is transmitted to the small base station.

The obtaining of results of access may include receiving an uplink data packet from the terminal, and the determining may include determining whether the access between the terminal and the small base station is completed when receiving the uplink data packet.

The method may further include: after the transmitting of a message for access, configuring, by the terminal, resources based on contents of the message for access and performing random access to the small base station; and transmitting, by the terminal, an uplink data packet to the small base station when receiving a response message including timing information from the small base station according to the random access.

The obtaining of results of access may include receiving an RRC connection reconfiguration complete message from the small cell access status message, and the determining may include perceiving that the access between the terminal and the small base station is completed when receiving the RRC connection reconfiguration complete message.

The transmitting of a message for access may include transmitting an RRC connection reconfiguration message including signaling radio bearer (SRB) information for signal transmission with the small base station to the terminal.

The RRC connection reconfiguration complete message may be transmitted to the small base station according to the SRB of the terminal when the uplink synchronization between the terminal and the small base station is completed, and then the RRC connection reconfiguration complete message from the small base station is sent to the macro base station.

The method may further include, after the determining, performing, by the macro base station, a follow-up procedure including traffic control between the terminal and the small base station when the access between the terminal and the small base station is successfully completed.

The method may further include, after the transmitting of a small cell addition/change request message, transmitting, by the small base station, the response message to the macro base station when accepting contents of the small cell addition/change request message.

Another embodiment of the present invention provides an apparatus for perceiving access in a network environment in which a macro base station and a small base station coexist. The apparatus includes: a radio frequency converter for transmitting and receiving a signal through a plurality of antennas; and a processor that is connected to the radio frequency converter and process-perceiving access between a terminal and a small base station. The processor includes: a small cell addition/change processor for transmitting a small cell addition/change request message to a small base station that the terminal enters and transmitting a message for access to the terminal when receiving a response message from the small base station; an access result obtaining processor for obtaining, by the macro base station, results of access between the terminal and the small base station and determining whether the access between the terminal and the small base station is completed based on the result of access; and a follow-up procedure processor for performing, by the macro base station, a follow-up procedure including traffic control between the terminal and the small base station when the access between the terminal and the small base station is successfully completed.

The access result obtaining processor may determine that the access between the terminal and the small base station is successfully completed in at least one case among the following cases. The following cases may include a case in which a small cell access status message including results of representing that random access to the small base station has succeeded is received from the terminal, a case in which a radio resource control (RRC) connection reconfiguration complete message including results of representing that random access to the small base station has succeeded is received from the terminal, a case in which a small cell status message including results of representing that random access by the terminal has succeeded is received from the small base station, a case in which an uplink data packet from the terminal is received from the small base station, and a case in which an RRC connection reconfiguration complete message is received from the small base station.

The small cell status message may be received from the small base station when the terminal receives a response message including timing information and uplink grant information from the small base station and then transmits a random access message based on the uplink grant information.

When the terminal receives an RRC connection reconfiguration message including signaling radio bearer (SRB) information for signal transmission with the small base station, uplink synchronization between the terminal and the small base station is completed, the small base station receives the RRC connection reconfiguration message according to the SRB of the terminal, and the RRC connection reconfiguration complete message may be received from the small base station.

### BRIEF DESCRIPTION OF THE DRAWINGS

FIG. 1 shows a network environment according to an exemplary embodiment of the present invention.

FIG. 2 shows a flowchart of a small cell addition procedure performed by a macro base station to provide dual connectivity.

FIG. 3 shows a flowchart of a method for a macro base station to perceive access between a small base station and a terminal according to a first exemplary embodiment of the present invention.

FIG. 4 shows a flowchart of a method for a macro base station to perceive access between a small base station and a terminal according to a second exemplary embodiment of the present invention.

FIG. 5 shows a flowchart of a method for a macro base station to perceive access between a small base station and a terminal according to a third exemplary embodiment of the present invention.

FIG. 6 shows a flowchart of a method for a macro base station to perceive access between a small base station and a terminal according to a fourth exemplary embodiment of the present invention.

FIG. 7 shows a flowchart of a method for a macro base station to perceive access between a small base station and a terminal according to a fifth exemplary embodiment of the present invention.

FIG. 8 shows a structure of an apparatus for perceiving access according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification, in addition, unless explicitly described to the contrary, the word “comprise” and variations such as “comprises” or “comprising” will be understood to imply the inclusion of stated elements but not the exclusion of any other elements.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the MT, the MS, the AMS, the HR-MS, the SS, the PSS, the AT, the UE, etc.

A base station (BS) may designate an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (HR-RS) serving as a base station, a high reliability relay station (HR-RS) serving as a base station, a small base station (femto BS, a home node B (HNB), a home eNodeB (HeNB), a pico BS, a metro BS, a micro BS, etc.), etc., and may include all or some functions of the ABS, the nodeB, the eNodeB, the AP, the RAS, the BTS, the MMR-BS, the RS, the RN, the ARS, the HR-RS, the small base station, etc.

Hereinafter, a method and apparatus for perceiving access between a small cell and a terminal according to an exemplary embodiment of the present invention will be described.

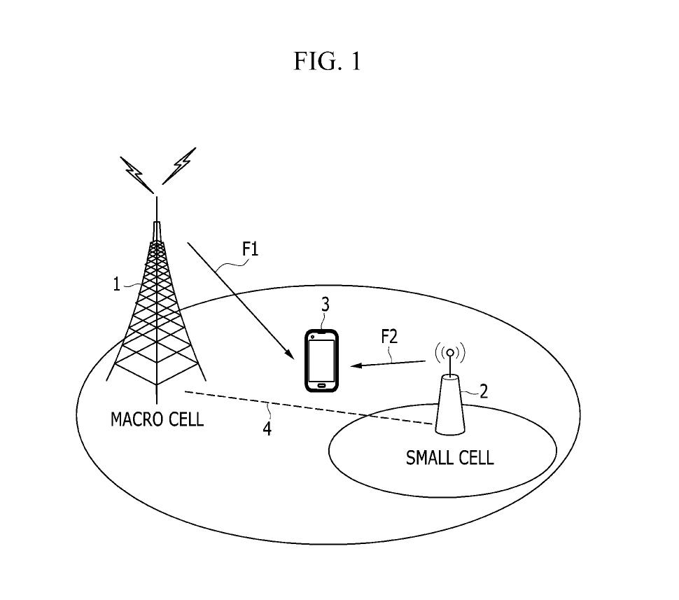

FIG. 1 shows a network environment according to an exemplary embodiment of the present invention.

As shown in FIG. 1, a network environment in which macro cells and small cells coexist is provided. A macro base station 1 and a small base station 2 provide services to a terminal 3 in the network environment. The macro base station 1 and the small base station 2 may be connected through a non-ideal backhaul 4.

When the terminal 3 being provided with services from the macro base station 1 (may be referred to as a master evolved node B (MeNB)) enters a new cell, the macro base station 1 commands the terminal 3 to set up a new bearer and to add it to bearers (radio bearers or evolved packet system (EPS) bearers) of the existing macro cell so that the terminal is additionally connected to the new cell, that is, a small base station 2 (may be referred to as a secondary eNB (SeNB)). Therefore, the terminal 3 forms dual connectivity between the macro base station 1 and the small base station 2. Here, the terminal 3 is provided with main control signals of a control plane through the macro base station 1, and is provided with data from the base stations 1 and 2. The macro base station 1 provides a frequency resource F1 to the terminal 3 and the small base station 2 provides a frequency resource F2 to the terminal 3. User data may be transmitted through the frequency resource F1 of the macro base station 1 to the terminal 3, and may also be transmitted through the frequency resource F2 of the small base station 2 to the terminal 3.

A procedure for providing the dual connectivity may be referred to as a small cell addition procedure or a small cell change procedure.

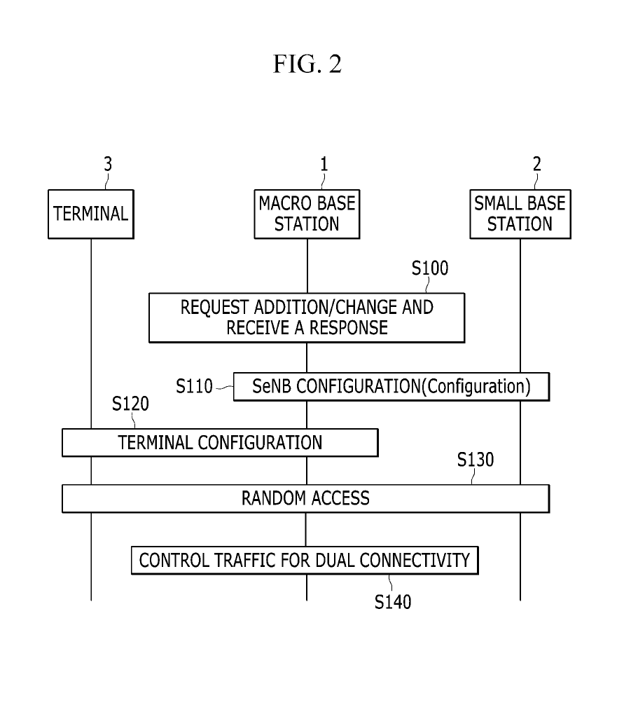

FIG. 2 shows a flowchart of a small cell addition procedure performed by a macro base station to provide dual connectivity.

As shown in FIG. 2, if a terminal 3 enters a new small cell, a macro base station 1 requests an addition/change process at a small base station 2 of the new small cell and receives a response (S100).

After that, the macro base station 1 commands the terminal 3 to set up a bearer with the small cell, and the small base station 2 and the terminal 3 set up a bearer for communication. For example, when receiving a bearer setup request message including information on the bearer from the terminal 2, the small base station 2 generates the bearer, maps the terminal 3 to the generated bearer, and transmits a message (e.g., a radio resource control (RRC) connection reconfiguration message) including information on the generated bearer to the terminal 3 (S110). The terminal 3 transmits a message (e.g., RRC connection reconfiguration complete message) to the small base station in response to the message received from the small base station 2 to activate the bearer (S120). When the small base station 2 receives the RRC connection reconfiguration complete message from the terminal 3, bearer activation is performed. Through the above procedure, the bearer for communication between the small base station 2 and the terminal 3 is set up.

The terminal 3 then performs a random access procedure to the small base station 2, and thereby access between the terminal 3 and the small base station 3 is completed (S130). On the successful completion of the random access procedure, the macro base station 1 may control traffic between the small base station 2 and the terminal 3 (S140).

The traffic control represents that a bearer via the macro base station 1 or a split for the bearer between the small base station 2 and the terminal 3 is path-switched to the small base station 2. The traffic control is dependent on the structure of a data plane in the small cell performance enhancement techniques. Controlling traffic between the small base station and the terminal by the macro base station has to be performed after the access between the small base station and the terminal is completed so that it is possible to prevent packet loss.

According to an exemplary embodiment of the present invention, during the small cell addition/change procedure, the macro base station perceives the access completion between the small base station and the terminal.

In a small cell addition procedure (SeNB addition) or a small cell change procedure (SeNB change), the macro base station obtains the results of random access procedure between the terminal and the small base station. The procedure for obtaining the results of random access may be performed as follows.

1. Procedure A: A terminal having received a response to a physical random access channel (PRACH) transmits a small cell access status message (or a SeNB access status message) to a macro base station.

2. Procedure B: A terminal having received a response to a PRACH transmits a RRC connection reconfiguration complete message to a macro base station.

3. Procedure C: A small base station having received a random access message (or an RA message #3) transmits a small cell status message (or an SeNB status message) to a macro base station.

4. Procedure D: A procedure for perceiving a case in which a macro base station receives an uplink data packet (UL data packet) as the result of a random access procedure between a terminal and a small base station.

5. Procedure E: An RRC connection reconfiguration complete message is transmitted to a macro base station through a path via a small base station.

In an exemplary embodiment of the present invention, a macro base station perceives the access completion between a small base station and a terminal based on the results of random access obtained according to the above procedures (Procedure A to Procedure E).

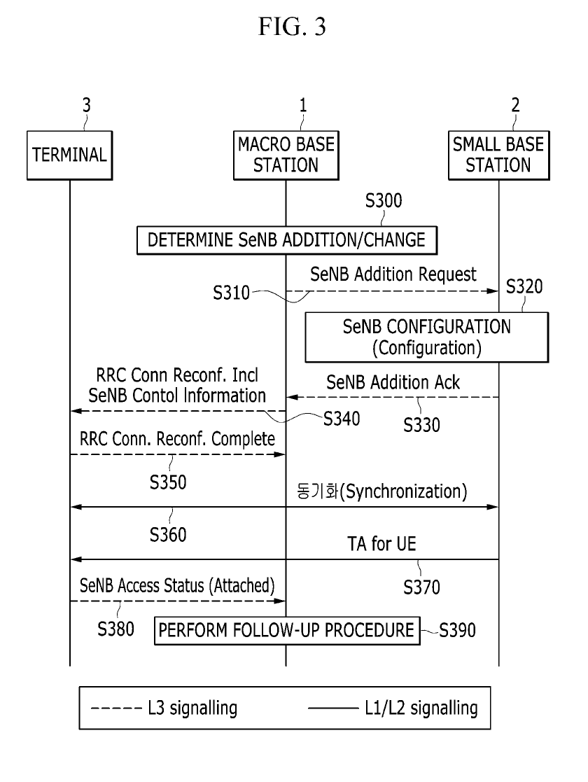

FIG. 3 shows a flowchart of a method for a macro base station to perceive access between a small base station and a terminal according to a first exemplary embodiment of the present invention.

In the first exemplary embodiment of the present invention, a macro base station perceives the access between a small base station and a terminal based on the results of random access obtained according to the Procedure A.

As shown in FIG. 3, when a terminal 3 enters a new small cell, a macro base station 1 determines small cell addition or small cell change (S300), and requests an addition/change process at a small base station 2 that participates in the process and receives a corresponding response.

The macro base station 1 transmits a small cell addition request message (SeNB Addition Request) to the small base station 2 (S310).

The small base station 2 having received the small cell addition request message (SeNB Addition Request) compares its ability and the contents of the message to determine whether it is possible to accept the requested contents. If it is possible, the small base station 2 transmits a small cell addition response message (SeNB Addition Ack) to the macro base station 1 (S320 and S330). The small base station 2 configures resources according to the requested contents.

The macro base station 1 receives the small cell addition response message (SeNB Addition Ack) and transmits an RRC connection reconfiguration message to the terminal 3 (S340).

The terminal 3 configures resources according to the contents of the RRC connection reconfiguration message, and then transmits an RRC connection reconfiguration complete message to the macro base station 1 when the resources configuration is completed (S350).

After that, the terminal 3 transmits a PRACH as the results of the resources configuration to the small base station 2 (S360). Here, after transmitting the RRC connection reconfiguration complete message, the PRACH is transmitted, but it is not restricted thereto. Since the PRACH is transmitted to the small base station, there is no sequential relationship between the time for transmitting the RRC connection reconfiguration complete message and the time for transmitting the PRACH.

The small base station 2 receives the PRACH for synchronization from the terminal 3 and then transmits a response message to the terminal 3 (S370). The small base station 2 uses a random access response (RAR) message or a timing alignment (TA) message as the response message for the PRACH. The response message may include information for synchronizing uplink transmission timing between the terminal 3 and the small base station 2.

The terminal 3 receives the information included in the response message for the PRACH so that synchronization for uplink with the small base station 2 is completed, and then the terminal 3 determines that random access (RA) has succeeded. After that, the terminal 3 transmits the results of representing RA success to the macro base station 1 (S380). According to an exemplary embodiment of the present invention, the terminal 3 transmits the results of the RA to the macro base station 1 by using a small cell access status message (SeNB Access Status).

The macro base station 1 perceives access between the terminal 1 and the small base station 2 based on the message received after the RA of the terminal 1 and the small base station 2. Specifically, the macro base station 1 stops the small cell addition (SeNB addition) or small cell change (SeNB change) procedure, and performs a procedure for returning to the initial configuration state when the small cell access status message received from the terminal 3 represents RA failure. Meanwhile, the macro base station 1 performs the procedure following to the small cell addition (SeNB addition) or small cell change (SeNB change) procedure when the small cell access status message received from the terminal 3 represents RA success.

In this way, the macro base station 1 perceives access between the terminal 1 and the small base station 2 based on the small cell access status message (SeNB Access Status) transmitted from the terminal having received the response for the PRACH, and then performs the following procedure (S390). After perceiving the RA success of the terminal, the macro base station 1 controls the traffic between the small base station 2 and the terminal 1 as in the following procedure. For example, the traffic control in which a bearer via the macro base station 1 or a split for the bearer between the small base station 2 and the terminal 3 is path-switched to the small base station 2 is performed as the following procedure. The traffic control is performed after it is perceived that the access between the terminal and the small base station is successfully completed, and thereby it is possible to prevent packet loss.

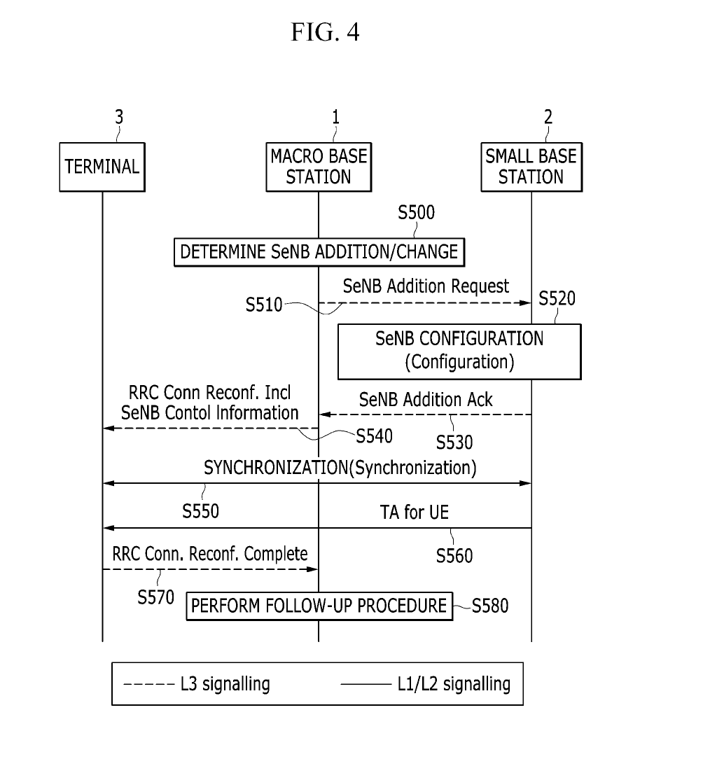

FIG. 4 shows a flowchart of a method for a macro base station to perceive access between a small base station and a terminal according to a second exemplary embodiment of the present invention.

In the second exemplary embodiment of the present invention, a macro base station perceives the access between a small base station and a terminal based on the results of random access obtained according to the Procedure B.

As shown in FIG. 4, when a terminal 3 enters a new small cell, a macro base station 1 determines small cell addition or small cell change (S500), and requests an addition/change process at a small base station 2 that participates in the process and receives a corresponding response.

The macro base station 1 transmits a small cell addition request message (SeNB Addition Request) to the small base station 2 (S510).

The small base station 2 having received the small cell addition request message (SeNB Addition Request) compares its ability and the contents of the message to determine whether it is possible to accept the requested contents. If it is possible, the small base station 2 transmits a small cell addition response message (SeNB Addition Ack) to the macro base station 1 (S520 and S530). The small base station 2 configures resources according to the requested contents.

The macro base station 1 receives the small cell addition response message (SeNB Addition Ack) and transmits an RRC connection reconfiguration message to the terminal 3 (S540).

The terminal 3 configures resources according to the contents of the RRC connection reconfiguration message, and then transmits a PRACH as the results of the resources configuration to the small base station 2 (S550).

The small base station 2 receives the PRACH for synchronization from the terminal 3 and then transmits a response message to the terminal 3 (S560). The small base station 2 uses a RAR message or a TA message as the response message for the PRACH. The response message may include information for synchronizing uplink transmission timing between the terminal 3 and the small base station 2.

The terminal 3 receives the information included in the response message for the PRACH so that synchronization for uplink with the small base station 2 is completed, and then the terminal 3 determines that random access (RA) has succeeded. After that, the terminal 3 transmits the results of the RA to the macro base station 1. In the second exemplary embodiment of the present invention, the terminal 3 uses an RRC connection reconfiguration complete message to transmit the results of the RA to the macro base station 1 (S570).

When the message received after the RA of the terminal 1 and the small base station 2, that is, the RRC connection reconfiguration complete message, represents RA failure, the macro base station 1 stops the small cell addition (SeNB addition) or small cell change (SeNB change) procedure and performs a procedure for returning to the initial configuration state. Meanwhile, when the RRC connection reconfiguration complete message represents RA success, the macro base station 1 performs the procedure following the small cell addition (SeNB addition) or small cell change (SeNB change) procedure (S580).

As stated above, the macro base station 1 perceives access between the terminal 1 and the small base station 2 based on the RRC connection reconfiguration complete message transmitted from the terminal having received the response for the PRACH, and then performs the following procedure.

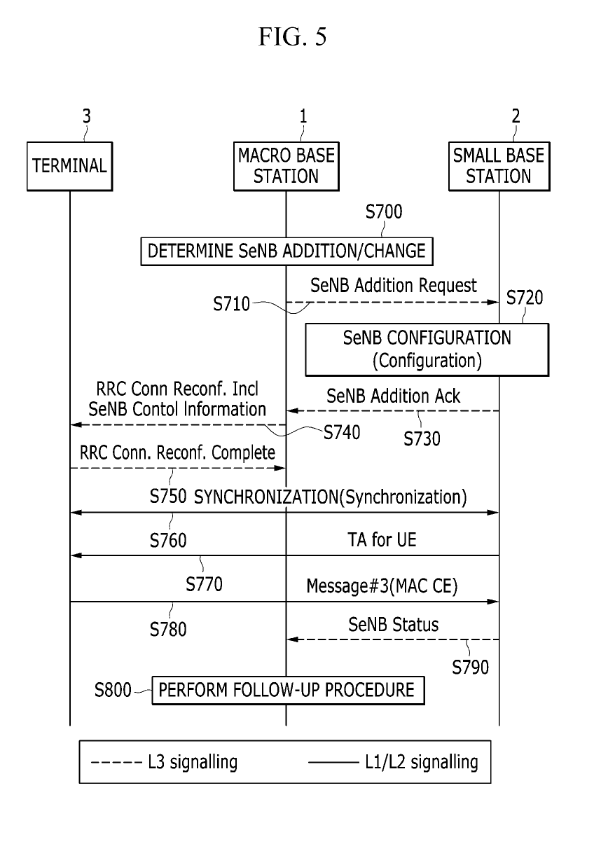

FIG. 5 shows a flowchart of a method for a macro base station to perceive access between a small base station and a terminal according to a third exemplary embodiment of the present invention.

In the third exemplary embodiment of the present invention, a macro base station perceives the access between a small base station and a terminal based on the results of random access obtained according to the Procedure C.

As shown in FIG. 5, when a terminal 3 enters a new small cell, a macro base station 1 determines small cell addition or small cell change (S300), and requests an addition/change process at a small base station 2 that participates in the process and receives a corresponding response.

The macro base station 1 transmits a small cell addition request message (SeNB Addition Request) to the small base station 2 (S710).

The small base station 2 having received the small cell addition request message (SeNB Addition Request) compares its ability and the contents of the message to determine whether it is possible to accept the requested contents. If it is possible, the small base station 2 transmits a small cell addition response message (SeNB Addition Ack) to the macro base station 1 (S720 and S730). The small base station 2 configures resources according to the requested contents.

The macro base station 1 receives the small cell addition response message (SeNB Addition Ack) and transmits an RRC connection reconfiguration message to the terminal 3 (S740).

The terminal 3 configures resources according to the contents of the RRC connection reconfiguration message, and then transmits an RRC connection reconfiguration complete message to the macro base station 1 when the resources configuration is completed (S750).

After that, the terminal 3 transmits a PRACH as the results of the resources configuration to the small base station 2 (S760). There is no sequential relationship between the time for transmitting the RRC connection reconfiguration complete message and the time for transmitting the PRACH.

The small base station 2 receives the PRACH for synchronization from the terminal 3, and then transmits a response message to the terminal 3 (S770). The small base station 2 may use a RAR message as the response message for the PRACH. The response message may include information for synchronizing uplink transmission timing between the terminal 3 and the small base station 2 and uplink (UL) grant information for a random access message (a RA message #3). When not receiving the RAR message, it is determined that the RA has failed. The terminal 3 stops the small cell addition (SeNB addition) or small cell change (SeNB change) procedure and performs a procedure for returning to the initial configuration state.

The terminal 3 receives the information included in the response message (that is, the RAR message) for the PRACH so that synchronization for uplink with the small base station 2 is completed, and then the terminal 3 determines that random access (RA) has succeeded. The terminal 3 transmits a random access message (RA message #3) to the small base station 2 based on the UL grant information that is included in the response message (that is, the RAR message) for the PRACH (S780).

When receiving the random access message (RA message #3) from the terminal 3, the small base station 2 determines that the RA has succeeded and transmits a small cell status message (SeNB Status) to the macro base station 1 (S790). According to the third exemplary embodiment of the present invention, the small cell status message (SeNB Status message) is used for reporting the results of the RA success to the macro base station.

When the message received after the RA of the terminal 1 and the small base station 2, that is, the small cell status message (SeNB Status) received from the small base station 2, represents RA failure, the macro base station 1 stops the small cell addition (SeNB addition) or small cell change (SeNB change) procedure and performs a procedure for returning to the initial configuration state. Meanwhile, the macro base station 1 performs the procedure following the small cell addition (SeNB addition) or small cell change (SeNB change) procedure when the small cell status message (SeNB Status) represents RA success (S800).

As stated above, the macro base station 1 perceives access between the terminal 1 and the small base station 2 based on the small cell status message received from the small base station 2 after the RA of the terminal 1 and the small base station 2, and performs the following procedure.

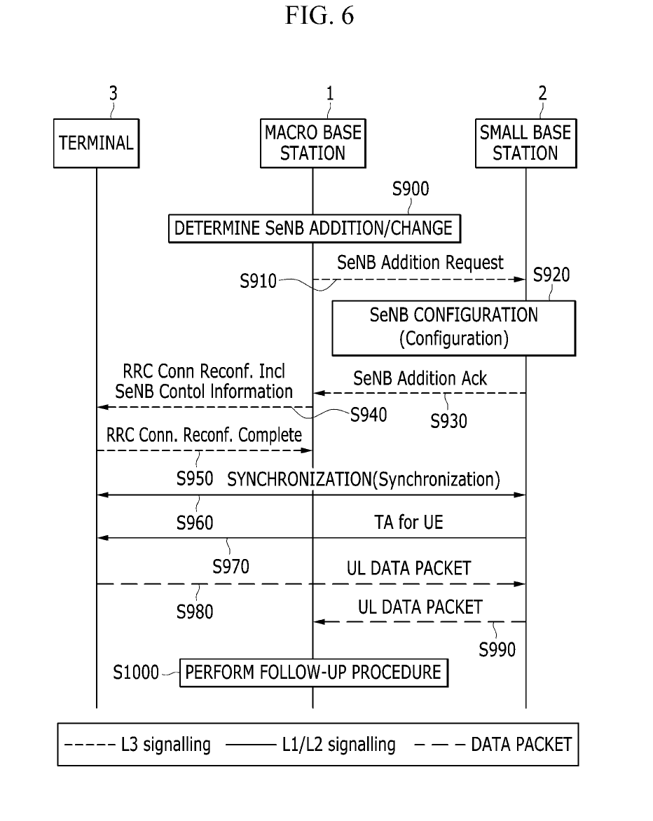

FIG. 6 shows a flowchart of a method for a macro base station to perceive access between a small base station and a terminal according to a fourth exemplary embodiment of the present invention.

In the first exemplary embodiment of the present invention, a macro base station perceives the access between a small base station and a terminal based on the results of random access obtained according to the Procedure D.

As shown in FIG. 6, when a terminal 3 enters a new small cell, a macro base station 1 determines small cell addition or small cell change (S900), and requests an addition/change process at a small base station 2 that participates in the process and receives a corresponding response.

The macro base station 1 transmits a small cell addition request message (SeNB Addition Request) to the small base station 2 (S910).

The small base station 2 having received the small cell addition request message (SeNB Addition Request) compares its ability and the contents of the message to determine whether it is possible to accept the requested contents. If it is possible, the small base station 2 transmits a small cell addition response message (SeNB Addition Ack) to the macro base station 1 (S920 and S930). The small base station 2 configures resources according to the requested contents.

The macro base station 1 receives the small cell addition response message (SeNB Addition Ack) and transmits an RRC connection reconfiguration message to the terminal 3 (S940).

The terminal 3 configures resources according to the contents of the RRC connection reconfiguration message, and then transmits an RRC connection reconfiguration complete message to the macro base station 1 when the resources configuration is completed (S950).

After that, the terminal 3 transmits a PRACH as the results of the resources configuration to the small base station 2 (S960). There is no sequential relationship between the time for transmitting the RRC connection reconfiguration complete message and the time for transmitting the PRACH.

The small base station 2 receives the PRACH for synchronization from the terminal 3 and then transmits a response message to the terminal 3 (S970). The small base station 2 uses a RAR message or a TA message as the response message for the PRACH. The response message may include information for synchronizing uplink transmission timing between the terminal 3 and the small base station 2. When not receiving the RAR message, it is determined that the RA has failed. The terminal 3 stops the small cell addition (SeNB addition) or small cell change (SeNB change) procedure and performs a procedure for returning to the initial configuration state.

The terminal 3 receives the information included in the response message (that is, the RAR message) for the PRACH so that synchronization for uplink with the small base station 2 is completed, and then the terminal 3 determines that random access (RA) has succeeded. After that, the terminal 3 transmits an uplink data packet (UL data packet) to the small base station 2 (S980). The small base station 2 sends the uplink data packet from the terminal 3 to the macro base station 1 (S990).

When the data received after the RA of the terminal 1 and the small base station 2, that is, the uplink data packet transmitted to the small base station by the terminal 3, is received, the macro base station 1 determines that the RA of the terminal 3 has succeeded and then performs the procedure following the small cell addition (SeNB addition) or small cell change (SeNB change) procedure (S1000). When the uplink data packet transmitted to the small base station by the terminal 3 is not received, the macro base station 1 determines that the RA of the terminal 3 has failed. Then, the macro base station stops the small cell addition (SeNB addition) or small cell change (SeNB change) procedure and performs a procedure for returning to the initial configuration state.

As stated above, the macro base station 1 perceives access between the terminal 1 and the small base station 2 based on receiving the uplink data packet after the RA between the terminal 3 and the small base station 2, and then performs the following procedure.

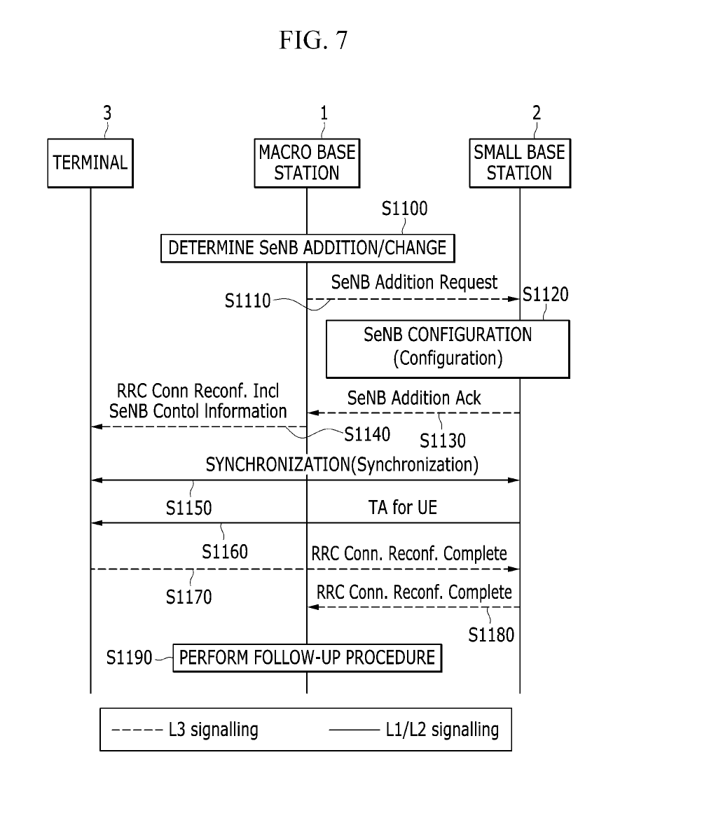

FIG. 7 shows a flowchart of a method for a macro base station to perceive access between a small base station and a terminal according to a fifth exemplary embodiment of the present invention.

In the fifth exemplary embodiment of the present invention, a macro base station perceives the access between a small base station and a terminal based on the results of random access obtained according to the Procedure E.

As shown in FIG. 7, when a terminal 3 enters a new small cell, a macro base station 1 determines small cell addition or small cell change (S1100), and requests an addition/change process at a small base station 2 that participates in the process and receives a corresponding response.

The macro base station 1 transmits a small cell addition request message (SeNB Addition Request) to the small base station 2 (S1110).

The small base station 2 having received the small cell addition request message (SeNB Addition Request) compares its ability and the contents of the message to determine whether it is possible to accept the requested contents. If it is possible, the small base station 2 transmits a small cell addition response message (SeNB Addition Ack) to the macro base station 1 (S1120 and S1130). The small base station 2 configures resources according to the requested contents.

The macro base station 1 receives the small cell addition response message (SeNB Addition Ack) and transmits an RRC connection reconfiguration message to the terminal 3 (S1140). According to the fifth exemplary embodiment of the present invention, the macro base station 1 adds information on wireless bearer setup for signal transmission with the small base station 2 to the configuration resource information of the RRC connection reconfiguration message. Specifically, signaling radio bearer (SRB) information for signal transmission with the small base station 2 is included in the configuration resource information. After that, an RRC connection reconfiguration complete message is sent to the small base station 2 through the SRB. For this purpose, the transmission of the RRC connection reconfiguration complete message is requested to the SRB according to the RRC.

The terminal 3 configures resources according to the contents of the RRC connection reconfiguration message, and then transmits a PRACH to the small base station 2 when the resources configuration is completed (S1150).

The small base station 2 receives the PRACH for synchronization from the terminal 3 and then transmits a response message to the terminal 3 (S1160). The small base station 2 uses a RAR message as the response message for the PRACH. The response message may include information for synchronizing uplink transmission timing between the terminal 3 and the small base station 2. The terminal 3 receives the information included in the response message for the PRACH so that synchronization for uplink with the small base station 2 is completed, and then the terminal 3 determines that the RA has succeeded. After that, the terminal 3 transmits a RRC connection reconfiguration complete message to the small base station 2 according to the SRB (S1170). Here, when receiving the RAR message has failed or the RA has failed by the failure of the RRC connection reconfiguration complete message transmission, the terminal 3 stops the small cell addition (SeNB addition) or small cell change (SeNB change) procedure and performs a procedure for returning to the initial configuration state.

The small base station 2 receives an RRC connection reconfiguration complete message from the terminal 3 and sends it to the macro base station 1 (S1180).

When the message after the RA of the terminal 1 and the small base station 2, that is, the RRC connection reconfiguration complete message from the small base station 2, is received, the macro base station 1 determines that the RA of the terminal 2 has succeeded. Then, the macro base station 1 performs the procedure following to the small cell addition (SeNB addition) or small cell change (SeNB change) procedure (S1190). When the RRC connection reconfiguration complete message from the small base station 2 is not received, the macro base station 1 determines that the RA of the terminal 2 has failed. The macro base station 1 stops the small cell addition (SeNB addition) or small cell change (SeNB change) procedure and performs a procedure for returning to the initial configuration state.

As stated above, the macro base station 1 perceives access between the terminal 1 and the small base station 2 when the RRC connection reconfiguration complete message is received from the small base station 2, and then performs the following procedure.

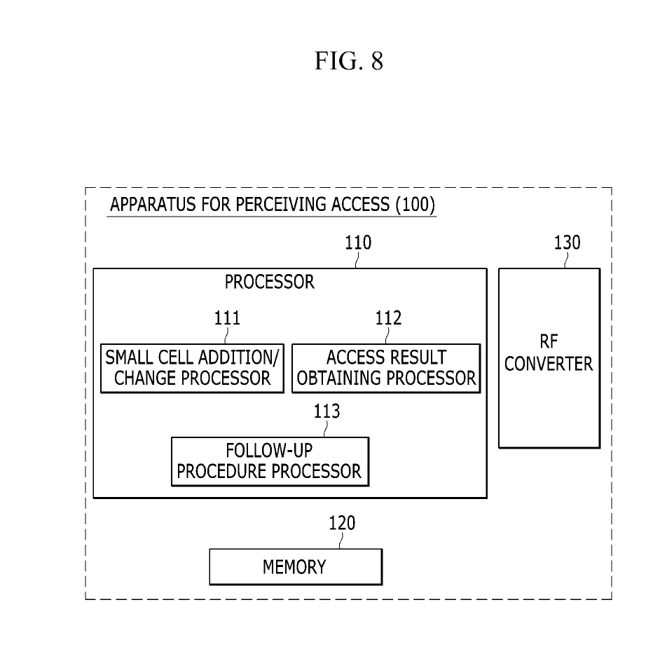

FIG. 8 shows a structure of an apparatus for perceiving access according to an exemplary embodiment of the present invention.

As shown in FIG. 8, an apparatus for perceiving access 100 includes a processor 110, a memory 120, and a radio frequency (RF) converter 130. The processor 110 is constructed to perform the procedures and methods described above based on FIG. 3 to FIG. 7.

The processor 110 includes a small cell addition/change processor 111, an access result obtaining processor 112, and a follow-up procedure processor 113.

The small cell addition/change processor 111 transmits a small cell addition/change request message to a small base station that a terminal enters, and transmits a message (e.g., an RRC connection reconfiguration message) for the small base station when receiving a response message to the small cell addition/change request message from the small base station.

The access result obtaining processor 112 obtains the results of access between the terminal and the small base station. The access result obtaining processor 112 obtains the results of access based on the above procedures (Procedure A to Procedure E). Specifically, the access result obtaining processor 112 perceives that the access between the terminal 1 and the small base station is completed when a small cell access status message including the results of the RA to the small base station is received from the terminal and the results of the RA represents access success. In addition, the access result obtaining processor 112 receives an RRC connection reconfiguration complete message including the results of the RA to the small base station from the terminal and perceives whether the access between the terminal 1 and the small base station is completed based on the results of the RA. Further, the access result obtaining processor 112 receives a small cell status message including the results of the RA from the small base station and perceives that the access between the terminal 1 and the small base station is completed when the results of the RA represents access success. Also, the access result obtaining processor 112 perceives that the access between the terminal 1 and the small base station is completed when receiving an uplink data packet from the terminal through the small base station. In addition, the access result obtaining processor 112 perceives that the access between the terminal and the small base station is completed when receiving an RRC connection reconfiguration complete message from the small base station.

The follow-up procedure processor 113 performs a follow-up procedure after the access between the terminal 1 and the small base station is successfully complete. Specifically, the follow-up procedure processor 113 controls traffic between the small base station and the terminal. The traffic control is performed after it is perceived that the access between the terminal 1 and the small base station is successfully completed, such that packet loss is prevented.

The memory 120 is connected to the processor 110 and stores information related to the operation of the processor 110. The RF converter 130 is connected to the processor 110 and receives or transmits a radio signal. The RF converter 130 may transmit and receive signals through multiple antennas.

According to an exemplary embodiment of the present invention, in a network environment in which macro base stations and small base stations coexist, the macro base station can perceive that access between the terminal and the small base station is successfully completed. After perceiving the access, the macro base station can control the traffic between the small base station and the terminal. Therefore, the traffic control in which a bearer via the macro base station or a split for the bearer between the small base station and the terminal is path-switched to the small base station 2 may be performed without packet loss. Accordingly, the traffic performance may be improved in the small cell performance enhancement techniques.

Also, when providing inter-node resource aggregation, the macro base station may connect the terminal to a newly discovered small base station and efficiently distribute traffic.

The exemplary embodiments of the present invention may be implemented through the above-described apparatus and/or method, and may also be implemented with a program for realizing the functions corresponding to the elements of the exemplary embodiments of the present invention, and a recording medium storing the program. These implementations may be easily achieved from the description of the exemplary embodiments by a person of ordinary skill in the art. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for perceiving access in a network environment in which a macro base station and a small base station coexist, comprising:
transmitting, by the macro base station, a small cell addition/change request message to a small base station that a terminal enters;
transmitting, by the macro base station, a message for access to the terminal when receiving a response message from the small base station;
obtaining, by the macro base station, results of access between the terminal and the small base station; and
determining, by the macro base station, whether the access between the terminal and the small base station is completed based on the result of access.

2. The method of claim 1, wherein the obtaining of results of access includes receiving a small cell access status message including results of random access to the small base station from the terminal, and
the determining includes perceiving that the access between the terminal and the small base station is completed when the results of the random access included in the small cell access status message represent access success.

3. The method of claim 1, wherein the transmitting of a message for access includes transmitting a radio resource control (RRC) connection reconfiguration message to the terminal, and
the obtaining of results of access includes receiving an RRC connection reconfiguration complete message including results of random access to the small base station from the terminal.

4. The method of claim 3, wherein the determining includes determining whether the access between the terminal and the small base station is completed based on the result of random access included in the RRC connection reconfiguration complete message received after the random access of the terminal to the small base station.

5. The method of claim 2, further comprising:
after the transmitting of a message for access,
configuring, by the terminal, resources based on contents of the message for access and performing random access to the small base station; and
transmitting, by the terminal, a message including results of the random access to the macro base station when receiving a response message including timing information from the small base station according to the random access.

6. The method of claim 1, wherein the obtaining of results of access includes receiving a small cell status message including results of random access from the small base station, and
the determining includes perceiving that the access between the terminal and the small base station is completed when the results of the random access included in the small cell status message represent access success.

7. The method of claim 6, further comprising:
after the transmitting of a message for access,
configuring, by the terminal, resources based on contents of the message for access and performing random access to the small base station;
receiving, by the terminal, a response message including timing information and uplink grant information from the small base station according to the random access; and
transmitting, by the terminal, a random access message to the small base station based on the uplink grant information.

8. The method of claim 7, wherein the small cell status message from the small base station is received by the macro base station when the random access message is transmitted to the small base station.

9. The method of claim 1, wherein the obtaining of results of access includes receiving an uplink data packet from the terminal, and
the determining includes determining whether the access between the terminal and the small base station is completed when receiving the uplink data packet.

10. The method of claim 9, further comprising:
after the transmitting of a message for access,
configuring, by the terminal, resources based on contents of the message for access and performing random access to the small base station; and
transmitting, by the terminal, an uplink data packet to the small base station when receiving a response message including timing information from the small base station according to the random access.

11. The method of claim 1, wherein the obtaining of results of access includes receiving an RRC connection reconfiguration complete message from the small cell access status message, and
the determining includes perceiving that the access between the terminal and the small base station is completed when receiving the RRC connection reconfiguration complete message.

12. The method of claim 11, wherein the transmitting of a message for access includes transmitting an RRC connection reconfiguration message including signaling radio bearer (SRB) information for signal transmission with the small base station to the terminal.

13. The method of claim 12, wherein the RRC connection reconfiguration complete message is transmitted to the small base station according to the SRB of the terminal when the uplink synchronization between the terminal and the small base station is completed, and then the RRC connection reconfiguration complete message from the small base station is sent to the macro base station.

14. The method of claim 1, further comprising,
after the determining,
performing, by the macro base station, a follow-up procedure including traffic control between the terminal and the small base station when the access between the terminal and the small base station is successfully completed.

15. The method of claim 1, further comprising,
after the transmitting of a small cell addition/change request message,
transmitting, by the small base station, the response message to the macro base station when accepting contents of the small cell addition/change request message.

16. An apparatus for perceiving access in a network environment in which a macro base station and a small base station coexist, comprising:
a radio frequency converter for transmitting and receiving a signal through a plurality of antennas; and
a processor that is connected to the radio frequency converter and process-perceiving access between a terminal and a small base station,
wherein the processor comprises:
a small cell addition/change processor for transmitting a small cell addition/change request message to a small base station that the terminal enters and transmitting a message for access to the terminal when receiving a response message from the small base station;
an access result obtaining processor for obtaining, by the macro base station, results of access between the terminal and the small base station and determining whether the access between the terminal and the small base station is completed based on the result of access; and
a follow-up procedure processor for performing, by the macro base station, a follow-up procedure including traffic control between the terminal and the small base station when the access between the terminal and the small base station is successfully completed.

17. The apparatus of claim 16, wherein
the access result obtaining processor determines that the access between the terminal and the small base station is successfully completed in at least one case among the following cases, including:
a case in which a small cell access status message including results of representing that random access to the small base station has succeeded is received from the terminal;
a case in which a radio resource control (RRC) connection reconfiguration complete message including results of representing that random access to the small base station has succeeded is received from the terminal;
a case in which a small cell status message including results of representing that random access by the terminal has succeeded is received from the small base station;
a case in which an uplink data packet from the terminal is received from the small base station; and
a case in which an RRC connection reconfiguration complete message is received from the small base station.

18. The apparatus of claim 17, wherein the small cell status message is received from the small base station when the terminal receives a response message including timing information and uplink grant information from the small base station and then transmits a random access message based on the uplink grant information.

19. The apparatus of claim 17, wherein when the terminal receives an RRC connection reconfiguration message including signaling radio bearer (SRB) information for signal transmission with the small base station, uplink synchronization between the terminal and the small base station is completed, the small base station receives the RRC connection reconfiguration message according to the SRB of the terminal, and the RRC connection reconfiguration complete message is received from the small base station.
